(19) United States
(12) Patent Application Publication
(10) Pub. No.: US 2015/0379905 A1
(43) Pub. Date: Dec. 31, 2015

(54) Infinity Lighting System for Transparent Media Display

(71) Applicant: Smoothweb Technologies Ltd., Hong Kong (HK)

(72) Inventors: Philip Kawasaki-Hedges, Tokyo (JP); Rajiv Trehan, Tokyo (JP)

(73) Assignee: Smoothweb Technologies Ltd., Hong Kong (HK)

(21) Appl. No.: 14/315,219

(22) Filed: Jun. 25, 2014

(51) Int. Cl. G09F 19/16; E06B 7/28; G09F 13/22; A47F 3/00; F21V 13/02; F21V 33/00

(52) U.S. Cl. CPC G09F 19/16; F21V 13/02; F21V 33/0044; G09F 13/22; A47F 3/001; A47F 3/007; E06B 7/28; F21Y 2101/02

(57) ABSTRACT

The present invention provides an infinity lighting system for transparent media display, the system comprising of: a glass panel; a mounting door or frame or bezel; plurality of lighting strip(s) or LED(s); a lighting diffuser; a polarized mirror-finished film; a transparent media display screen; and a mask or scratch resistant clear panel; wherein, said plurality of lighting strip(s) or LED(s) mounted in the periphery between a glass panel and the transparent media display screen, for generating numerous reflections to create infinite lighting effects, which enhances visibility and clarity of the transparent media display and visibility of product(s) stored in a container or in a display body.

### FIELD OF THE INVENTION

The present invention relates to an infinity lighting system and transparent media display. More particularly, the infinity lighting system, having at least one transparent media display screen and at least one lighting strip, which is mounted in the periphery between a glass panel and the transparent media display screen, to create different reflected light effects, when attached to a container or window that allows items to be viewed clearly on the inside and illuminating the transparent media display screen.

### BACKGROUND OF THE INVENTION

The display systems with transparent media display are being installed on the fridge(s), container(s) and food dispenser(s) which act as a platform for business and advertisement. These display systems are generally kept in public places to conduct business. Therefore, the foremost requirement for these systems is to be visible from a distance. More specifically, with these transparent display systems the screen should attract attention from as far as possible with a clear and crisp image, plus there should be enough light in the container so that the product(s) inside the container are visible. Therefore, the lighting system that illuminates the screen and the storage container plays a vital role in enhancing visibility. A perfect lighting system should ideally balance the illumination on the screen and the product(s) stored in the container.

In market there are several lighting systems available for transparent media display. These lighting systems are boundary lighting system that is disposed on the door frame that provides access into the container. The system comprises of: a container for storing product(s); a transparent media display screen coupled to the container, the transparent media display screen allowing visual inspection of product(s) stored within the container through the media display screen; and a boundary lighting system disposed within the container body or on the door frame adjacent to an outer edge of the transparent media display screen.

A few examples of such systems such as in U.S. Pat. No. 8,672,427B2, wherein it discloses a display system comprising of: a container body that defines a compartment for storing product(s); a transparent media display screen coupled to the container body; the transparent media display screen allowing visual inspection of product(s) stored within the compartment through the media display screen; and a boundary lighting system disposed within the container body adjacent an outer edge of the transparent media display screen. The boundary lighting system also backlights the transparent media display screen and further the light being redirected into the compartment to illuminate product(s) within the compartment.

In US20100180615A, provides an improved display refrigerator with a transparent display door that includes an LED-based lighting system integrated about all or a portion of the interior periphery thereof. The LED-based lighting system is preferably arranged as one or more linear arrays of LED lights that are operatively angled to optimally illuminate the contents stored within the display refrigerator. The LED system is integrated within the periphery of the refrigerator door, which is not only space efficient, but substantially minimizes the ability of such lighting system to become damaged or broken.

In WO2013056109A1, provides a transparent LCD within the door of a display case. A plurality of LEDs that may be positioned within or near the door assembly to provide additional illumination of the interior of the display case, reflecting and diffusing off the product(s) within the display case, creating a backlight for the transparent LCD. Each LED is positioned between a pair of vertical louvers so as to direct the light away from the LCD and towards the rear of the display case (or towards the goods within the display case). Alternatively, a lighting flange is described that may extend from the sidewall of the center channel and angle towards the rear of the compartment so as to direct the light away from the transparent media displays and towards the rear of the display compartment (or towards the goods within the display case).

All these lighting systems are integral part of the container and are specifically not designed for illuminating transparent media display screen and to produce a fully visible interior container and display screen. Hence, there is a need for an advanced system and method for displaying and advertising of beverage(s) or product(s) stored within interior of a container by infinity lighting effect.

### SUMMARY OF THE INVENTION

One aspect of the present invention is an infinity lighting system for transparent media display, the system comprising of: a glass panel; a mounting frame; plurality of lighting strip(s) or LED(s); a lighting diffuser; a polarized mirror-finished film; a transparent media display screen; and a mask or scratch resistant clear panel; said plurality of lighting strip(s) or LED(s) is/are mounted in the periphery between a glass panel and a transparent media display screen, said lighting diffuser may be integrated to lighting strip(s) or LED(s), said polarized mirror finished film is placed on the back surface of the transparent media display screen, said transparent media display screen is for viewing, displaying and advertising, said mask or scratch resistant clear panel acts as a protective covering, and is operatively aligned with the transparent media display screen to enable illumination from the said lighting strip(s) or LED(s) to pass therethrough, said mounting frame may be affixed to a door of a container or transparent window or an open frame, wherein, the infinity lighting system can be fitted or retro-fitted to container or transparent window or frame, through which product(s) stored within interior of the said container or transparent window or frame may be viewed, and enhances the visibility of product(s) stored within the said container or transparent window or frame.

Another aspect of the present invention is an infinity lighting system for displaying and advertising of beverage(s) or product(s), the infinity lighting system comprising: glass panel; a mounting door or frame or bezel; plurality of lighting strip(s) or LED(s); a lighting diffuser; a polarized mirror-finished film; a transparent media display screen; and a mask or scratch resistant clear panel; wherein, said plurality of lighting strip(s) or LED(s) is/are mounted in the periphery between a glass panel and the transparent media display screen, for generating numerous reflections to create infinite light effects, which enhances visibility and clarity of the transparent media display, and also enhances visibility of product(s) stored within interior of a container.

In another aspect of the present invention is a method for displaying and advertising of beverage(s) or product(s) by infinity lighting system, the method comprising: affixing an infinity lighting system to door of a container; wherein, the said infinity lighting system having at least one transparent media display screen through which product(s) stored within interior of the said container may be viewed, further plurality of lighting strip(s) or LED(s) is/are mounted in the periphery between a glass panel and the transparent media display screen to create different reflected light effects to enhance the lighting quality and a mask or scratch resistant clear panel as a protective covering, and operatively aligned with transparent media display screen to enable illumination from said lighting strip(s) or LED(s) to pass therethrough.

One advantage of the infinity lighting system and transparent display media screen is that it is adapted for simultaneous visual inspection of the display media content(s) whilst also allowing a user to see the product(s) within the container or behind the window of a shop.

Another advantage of the present invention is an infinity lighting system for transparent media display to be separately attached to a door of a container or a window of a display body and the door or window can be opened/closed without any risk of damaging the system or product(s) stored in the container or in a shop.

Another advantage of the present invention is promoting product(s) or beverages(s) stored interiorly in the container and generate interest by capturing the attention of potential consumers. The transparent media display screen coupled to the container door may also incorporate touch screen capabilities to improve user interactions. Furthermore, the container or fridge is capable of network communication(s) and all the function(s) of an advanced computer system, which could allow gaming, communication with social networks, participation in promotions etc.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exploded view of infinity lighting system, in which various embodiments of the present invention may be practiced.

FIG. 2 illustrates an exploded view of infinity lighting system with a container, in which various embodiments of the present invention may be practiced.

FIG. 3 is an exemplary of an infinity lighting system displaying and advertising of media content(s), in which various embodiments of the present invention may be practiced.

FIG. 4 is an exemplary of an infinity lighting system with different lighting effects and beverage(s) or product(s) stored within a container, in which various embodiments of the present invention may be practiced.

FIG. 5 is an exemplary of an infinity lighting system with different lighting effects, beverage(s) or product(s) stored within a container and displaying and advertising of media content(s) on the transparent media display screen, in which various embodiments of the present invention may be practiced.

FIG. 6 is an exemplary of an infinity lighting system affixed to different/multiple sides of a container, in which various embodiments of the present invention may be practiced.

FIG. 7 is an exemplary of an infinity lighting system affixed to different/multiple sides of a container with different lighting effects, in which various embodiments of the present invention may be practiced.

### DETAIL DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

An embodiment of the present invention provides an infinity lighting system for transparent media display, the system comprising of: a glass panel; a mounting frame; plurality of lighting strip(s) or LED(s); a lighting diffuser; a polarized mirror-finished film; a transparent media display screen; and a mask or scratch resistant clear panel; said plurality of lighting strip(s) or LED(s) mounted in the periphery between a glass panel and the transparent media display screen, said lighting diffuser may be integrated to lighting strip(s) or LED(s), said polarized mirror finished film is placed on the back surface of the transparent media display screen, said transparent media display screen is for viewing, displaying and advertising, said mask or scratch resistant clear panel acts as a protective covering, and is operatively aligned with the transparent media display screen to enable illumination from the said lighting strip(s) or LED(s) to pass therethrough, said mounting frame may be affixed to a door of a container, wherein, the infinity lighting system can be individually retro-fitted to container(s), through which product(s) stored within interior of the said container may be viewed, and enhances the visibility of product(s) stored within the said container.

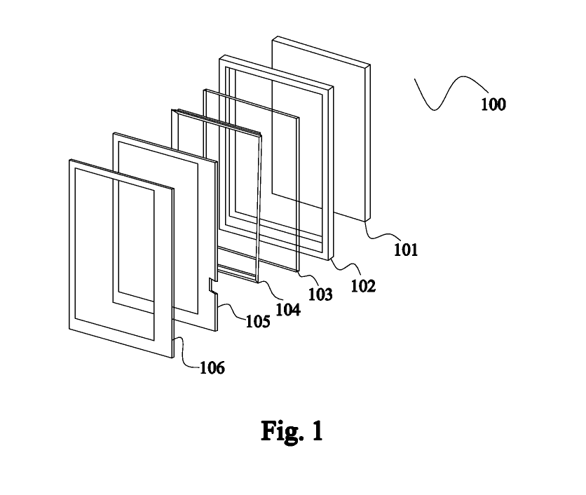

FIG. 1 shows an exploded view of infinity lighting system of the present invention. The infinity lighting system (100) comprising of: a glass panel (101); a mounting door or frame or bezel (102); plurality of lighting strip(s) or LED(s) (103); a lighting diffuser (104); a polarized mirror-finished film (not shown in the diagram); a transparent media display screen (105); and a mask or scratch resistant clear panel (106). Further, the plurality of lighting strip(s) or LED(s) (103) is/are mounted in the periphery between a glass panel (101) and the transparent media display screen (105). The polarized mirror-finished film is placed on the back surface of the transparent media display screen (105). The mask or scratch resistant clear panel (106) acts as a protective covering, and is operatively aligned with the transparent media display screen (105) to enable illumination from the lighting strip(s) or LED(s) (103) to pass therethrough. And the mounting door or frame or bezel (102) may be affixed to a displaying side(s) of a container or glass door of container.

An infinity lighting system for transparent media display wherein the said glass panel is a multilayered clear glass sheet which increases the amount of reflections.

An infinity lighting system for transparent media display wherein said plurality of lighting strip(s) or LED(s) is used optionally, either separately or together with a lighting diffuser to create different reflected effects. The lighting strip may further include other lighting devices. The transparent media display screen includes but not limited to is LED, LCD, OLED.

An infinity lighting system for transparent media display wherein said polarized mirror-finished film, which is optionally placed on the back surface of the transparent media display screen to reflect the light to enhances the illumination of product(s) stored within a container, the said mask or scratch resistant clear panel is affixed on the front for protecting the transparent media display screen and also used for aesthetic purposes.

Another embodiment of the present invention provides an infinity lighting system for displaying and advertising of beverage(s) or product(s), the infinity lighting system comprising: glass panel; a mounting door or frame or bezel; plurality of lighting strip(s) or LED(s); a lighting diffuser; a polarized mirror-finished film; a transparent media display screen; and a mask or scratch resistant clear panel; wherein, said plurality of lighting strip(s) or LED(s) is/are mounted in the periphery between a glass panel and the transparent media display screen, for generating numerous reflections to create infinite light effects, which enhances visibility and clarity of the transparent media display, and also enhances visibility of product(s) stored within interior of a container or behind a window.

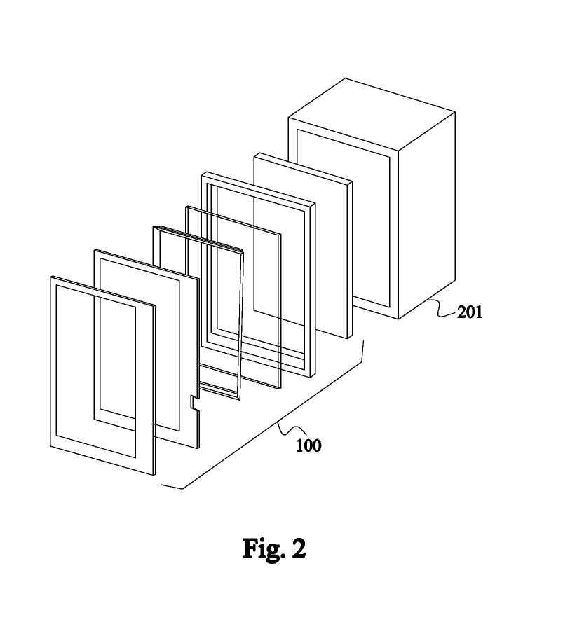

FIG. 2 shows an exploded view of infinity lighting system (100) of the present invention with a container (201). The infinity lighting system (100) is installed separately to a container (201) wherein, the container (201) can have more than one opening door or transparent side. The container (201) includes but is not limited to fridge or dispenser or oven and can be of various different shape(s) or size(s). Also the container (201) can be cooling container(s) or non-cooling container(s) or rack(s) used for storing and displaying, and made of metallic or non-metallic materials.

An infinity lighting system of the present invention for displaying and advertising of beverage(s) or product(s), in which the lighting diffuser may be optionally integrated to lighting strip to create different reflected effect(s) i.e. the bare lighting system or diffused system, may be used. Furthermore, the polarized mirror-finished film may also be optionally placed on the back surface of the transparent media display screen to reflect the light to illuminate product(s) stored within container.

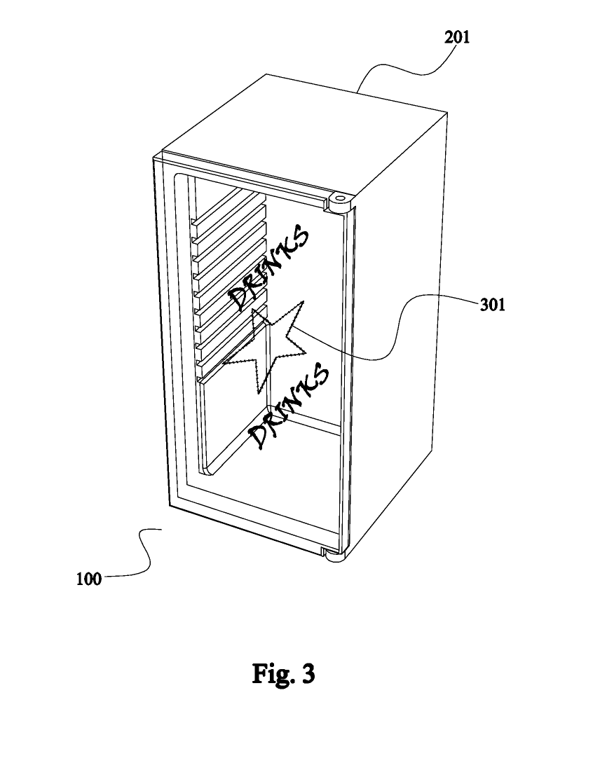

FIG. 3 shows an exemplary of an infinity lighting system (100) displaying and advertising of media content(s) on a container (201). The media content(s) (301) is/are displayed on the transparent media display screen of the infinity lighting system. The media content(s) (301) can be, but is not limited to text(s), image(s), video(s) or animation(s), brand(s). The transparent media display screen can be further used for displaying live image(s) or video(s).

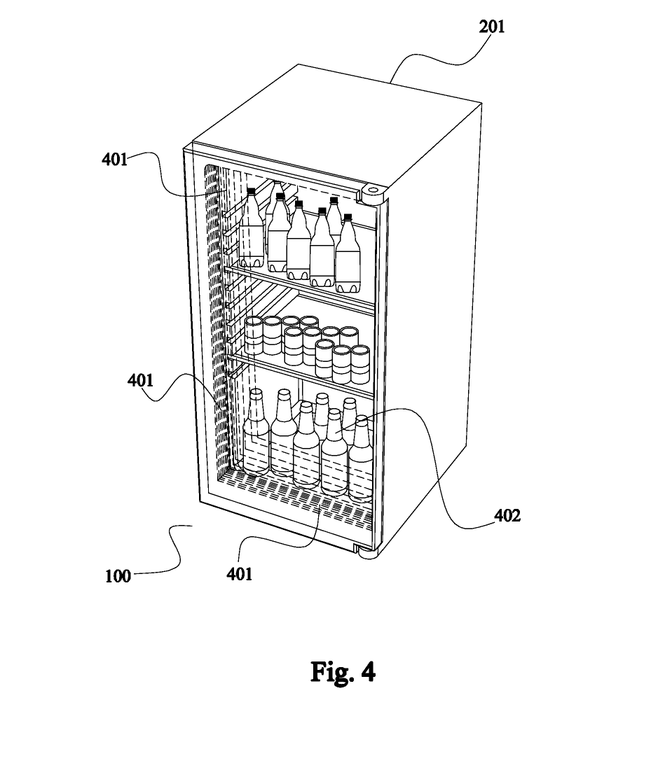

FIG. 4 shows an exemplary of an infinity lighting system (100) with different lighting effects (401) and beverage(s) or product(s) (402) stored within a container (201). In which, beverage(s) or product(s) stored (402) within interior of the container (201) is clearly visible through transparent media display.

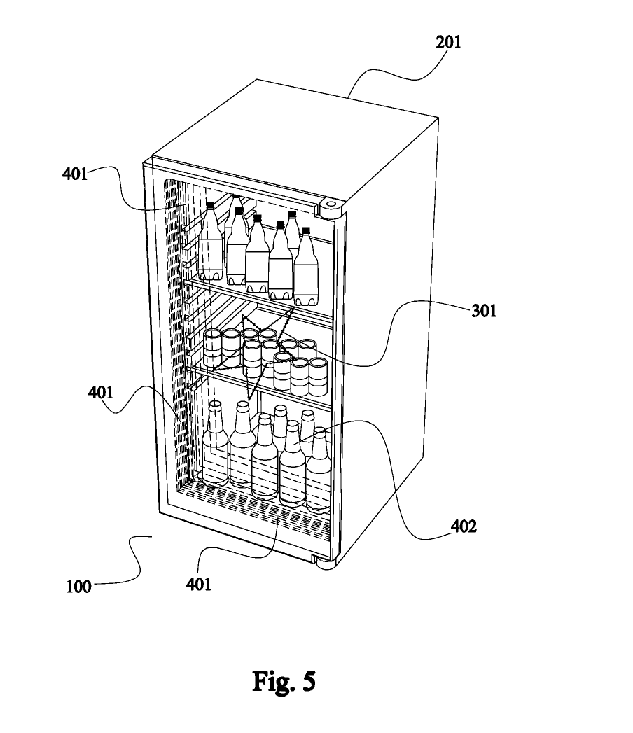

FIG. 5 shows an exemplary of an infinity lighting system (100) with different lighting effects (401) where beverage(s) or product(s) (402) stored within a container (201) and displaying and advertising of media content(s) (301) on the transparent media display screen. In which, beverage(s) or product(s) (402) stored within interior of the container (201) is clearly visible through transparent media display screen and simultaneously media content(s) is also displayed on the transparent media display screen.

In another embodiment of the present invention provides a method for displaying and advertising of beverage(s) or product(s) by infinity lighting system, the method comprising: affixing an infinity lighting system to door or window of a display body; wherein, the said infinity lighting system having at least one transparent media display screen through which product(s) stored inside the display body may be viewed, further plurality of lighting strip(s) or LED(s) are mounted between the glass panel and the transparent media display screen around periphery to create different reflected light effects to enhance the lighting quality and a mask or scratch resistant clear panel as a protective covering, and operatively aligned with transparent media display screen to enable illumination from said lighting strip(s) or LED(s) to pass therethrough.

A method for displaying and advertising of beverage(s) or product(s) stored within a container by infinity lighting system, where the transparent media display screen is used for displaying text(s), image(s), video(s) or animation(s), brand(s) and other media events.

A method for displaying and advertising of beverage(s) or product(s) stored within a container by infinity lighting system, the said infinity lighting system generates numerous reflections to create infinite light effects, which enhances visibility and clarity of transparent media display screen and visibility of product(s) stored interior of said container.

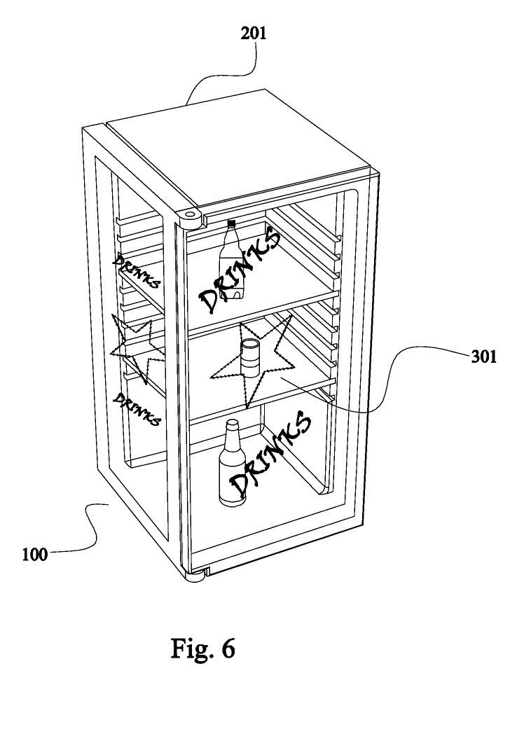

FIG. 6 show an infinity lighting system (100) affixed to different/multiple sides of a container (201). The media content(s) (301) is/are displayed on the transparent media display screen of the infinity lighting system (100). For illustrative purpose, only two sides of a container (201) is shown with infinity lighting system (100) but it can be affixed to any remaining sides of the container (201) to attract the attention of a customer passing by the area.

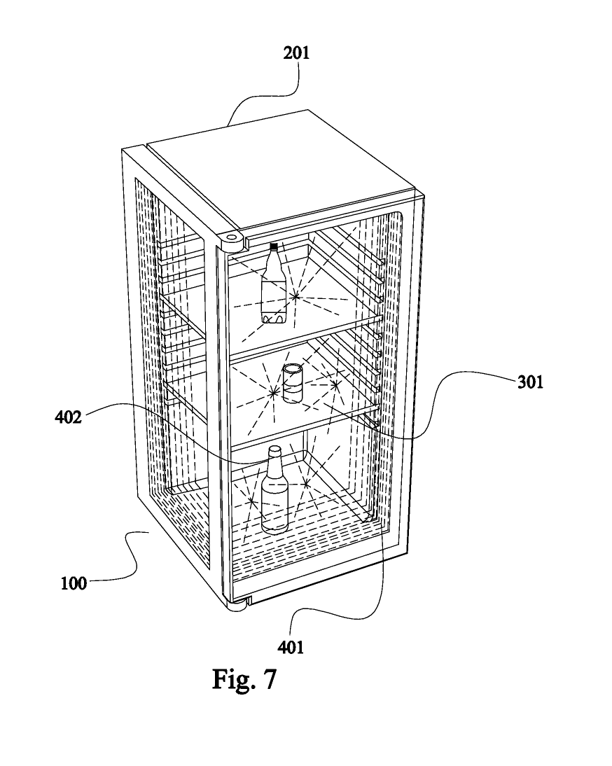

FIG. 7 show an exemplary of an infinity lighting system (100) affixed to different/multiple sides of a container (201). Where, beverage(s) or product(s) (402) stored within interior of the container (201) is clearly visible through the transparent media display screen with numerous reflections by creating different lighting effects.

One advantage of the infinity lighting system and transparent display media screen is that it is adapted for simultaneous visual inspection of the display media content(s) whilst also allowing a user to see the product(s) within the container or behind the window of a shop.

Another advantage of the present invention is an infinity lighting system for transparent media display to be separately attached to a door of a container or a window of a display body and the door or window can be opened/closed without any risk of damaging the system or product(s) stored in the container or in a shop.

Another advantage of the present invention is promoting product(s) or beverages(s) stored interiorly in the container or inside a shop and generate interest by capturing the attention of potential consumers. The transparent media display screen coupled to the container door or window of a shop may also incorporate touch screen capabilities to improve user interactions. Furthermore, the container or fridge is capable of network communication(s) and all the function(s) of an advanced computer system, which could allow gaming, communication with social networks, participation in promotions etc.

Another advantage of the present invention is its ability to display media content such as graphic image(s) or video(s) on transparent media display screen that is enabled or controlled by a software applications or program for the media player or application used.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. An infinity lighting system for transparent media display, the system comprising of:
a glass panel;
a mounting frame;
plurality of lighting strip(s) or LED(s);
a lighting diffuser;
a polarized mirror-finished film;
a transparent media display screen; and
a mask or scratch resistant clear panel;
said plurality of lighting strip(s) or LED(s) is/are mounted in the periphery between a glass panel and the transparent media display screen,
said lighting diffuser may be integrated to lighting strip(s) or LED(s),
said polarized mirror finished film is placed on the back surface of the transparent media display screen,
said transparent media display screen is for viewing, displaying and advertising, said mask or scratch resistant clear panel acts as a protective covering, and is operatively aligned with the transparent media display screen to enable illumination from the said lighting strip(s) or LED(s) to pass therethrough,
said mounting frame may be affixed to a door of a container,
wherein, the infinity lighting system can be individually retro-fitted to container(s), through which product(s) stored within interior of the said container may be viewed, and enhances the visibility of product(s) stored within the said container.

2. An infinity lighting system for transparent media display of claim 1, wherein the said plurality of lighting strip(s) or LED(s) is used separately or together with a lighting diffuser to create different reflected effects.

3. An infinity lighting system for transparent media display of claim 1, wherein the said glass panel is a multilayered clear glass sheet which increases the amount of reflections.

4. An infinity lighting system for transparent media display of claim 1, wherein the said lighting diffuser may be optionally integrated to lighting strip(s) or LED(s).

5. An infinity lighting system for transparent media display of claim 1, wherein the said polarized mirror-finished film is placed on the back surface of the transparent media display screen for increasing number of reflections to enhance the quality of luster or lighting effect.

6. An infinity lighting system for transparent media display of claim 1, wherein the said transparent media display screen includes but is not limited to LED, LCD, OLED.

7. An infinity lighting system for transparent media display of claim 1, wherein the said mask or scratch resistant clear panel is optionally used as a protective covering, and which is operatively aligned with transparent media display screen to enable illumination from said lighting strip(s) or LED(s) to pass therethrough.

8. An infinity lighting system for transparent media display of claim 1, wherein the said system is individually used/attached with any or all cooling container(s) or non-cooling container(s) of different shape(s) and size(s) or window (a shop window).

9. An infinity lighting system for displaying and advertising of beverage(s) or product(s), the infinity lighting system comprising:
a. a glass panel;
b. a mounting door or frame or bezel;
c. plurality of lighting strip(s) or LED(s);
d. a lighting diffuser;
e. a polarized mirror-finished film;
f. a transparent media display screen; and
g. a mask or scratch resistant clear panel;
wherein, said plurality of lighting strip(s) or LED(s) is/are mounted in the periphery between a glass panel and the transparent media display screen, for generating numerous reflections to create infinite light effects, which enhances visibility and clarity of the transparent media display, and also enhances visibility of product(s) stored within interior of a container.

10. An infinity lighting system of claim 9, wherein the said plurality of lighting strip(s) or LED(s) is used separately or together with a lighting diffuser to create different reflected effects.

11. An infinity lighting system of claim 9, wherein the said polarized mirror-finished film is optionally placed on the back surface of the transparent media display screen for producing infinite reflections to illuminate product(s) stored within the said container.

12. An infinity lighting system of claim 9, wherein the said transparent media display screen includes but is not limited to LED, LCD, OLED.

13. An infinity lighting system of claim 9, wherein the said mask or scratch resistant clear panel is for protecting the transparent media display screen and can be additionally used for aesthetic purpose(s).

14. An infinity lighting system of claim 9, wherein the said mask or scratch resistant clear panel is preferably transparent.

15. A method for displaying and advertising of beverage(s) or product(s) by infinity lighting system, the method comprising:
affixing an infinity lighting system to door or window of a display body;
wherein, the said infinity lighting system having at least one transparent media display screen through which product(s) stored inside the display body may be viewed, further plurality of lighting strip(s) or LED(s) are mounted between the glass panel and the transparent media display screen around periphery to create different reflected light effects to enhance the lighting quality and a mask or scratch resistant clear panel as a protective covering, and operatively aligned with transparent media display screen to enable illumination from said lighting strip(s) or LED(s) to pass therethrough.

16. A method of claim 15, wherein the said transparent media display screen is preferably used for displaying text(s), image(s), video(s) or animation(s), brand(s) and other media events.

17. A method of claim 15, wherein the said infinity lighting system generates numerous reflections to create infinite light effects, which enhances visibility and clarity of the transparent media display and visibility of product(s) stored inside the display body.
